(19) United States
(12) Patent Application Publication
(10) Pub. No.: US 2015/0095435 A1
(43) Pub. Date: Apr. 2, 2015

(54) SERVER, INFORMATION PROCESSING APPARATUS, METHOD, AND RECORDING MEDIUM

(71) Applicant: PFU LIMITED, Kahoku-shi (JP)

(72) Inventors: Keiichi Kasai, Kahoku-shi (JP); Keisuke Kai, Kahoku-shi (JP)

(73) Assignee: PFU LIMITED, Kahoku-shi (JP)

(21) Appl. No.: 14/253,360

(22) Filed: Apr. 15, 2014

(30) Foreign Application Priority Data
Sep. 30, 2013 (JP) 2013-203886

(51) Int. Cl. H04L 12/58

(52) U.S. Cl. CPC H04L 51/32
USPC 709/206

(57) ABSTRACT

A server is provided with: a group management section that manages on a group-by-group basis a user belonging to a group for information sharing; a reception section that receives a message transmitted from a user terminal; a time limit setting section that sets a time limit to data sharing in the group based on destination information of the message; a sharing section that causes data transmitted from the user terminal of the user belonging to the group to be shared by users belonging to a specified group; and an invalidation section that invalidates the sharing by the sharing section in accordance with the time limit.

### CROSS-REFERENCE TO RELATED APPLICATION

This application is based upon and claims the benefit of priority of the prior Japanese Patent Application No. JP2013-203886, filed on Sep. 30, 2013, the entire contents of which are incorporated herein by reference.

### FIELD

The present disclosure relates to a technique for sharing information between a plurality of terminals.

### BACKGROUND

Conventionally, a mail mediation system has been proposed in which a period before a temporary address is deleted is set in advance as an initial value or set based on a mail requesting the generating of the temporary address from a first user and a temporary address deletion section is provided to delete the temporary address based on the set period before the temporary address is deleted (see Japanese Patent Application Laid-open No. 2009-86916).

In addition, an information processing apparatus has been proposed which deletes an electronic mail address in accordance with a time elapsed from the generating of the electronic mail address (see Japanese Patent Application Laid-open No. 2003-141042). Further, an electronic mail server having a time-limited address converting function has been proposed which has a validity period specification unit that specifies a period of validity for a temporary mail address, and a time limit determination unit that determines whether or not the temporary mail address is within the period of validity (see Japanese Patent Application Laid-open No. 2009-188960).

### SUMMARY

An example of the present disclosure is a server including: a group management unit that manages on a group-by-group basis a user belonging to a group for information sharing on; a message reception unit that receives a message transmitted from a user terminal; a time limit setting unit that sets a time limit for data sharing in the group based on destination information of the message; a data reception unit that receives data transmitted from the user terminal of the user belonging to the group; a sharing unit that causes the data to be shared by users belonging to a group specified when the data is transmitted; and an invalidation unit that invalidates the sharing by the data sharing unit in accordance with the time limit.

The present disclosure can also be understood as a method to be executed by an information processing apparatus, a system, or a computer or a program to be executed by a computer.

The present disclosure can also be understood as such a program recorded on a recording medium which is readable by a computer or another device, machine, or the like.

Here, a recording medium which is readable by a computer or the like refers to a recording medium in which information such as data or a program is stored by an electrical, magnetic, optical, mechanical, or chemical operation and from which the information can be read from a computer or the like.

### BRIEF DESCRIPTION OF THE DRAWINGS

FIG. 1 is a view showing the outline of a configuration of a system according to an embodiment;

FIG. 2 is a view showing the outline of a functional configuration of a server and an information processing apparatus according to the embodiment;

FIG. 3 is a flowchart showing the flow of a process executed by the information processing apparatus in the embodiment;

FIG. 4 is a flow chart showing the flow of a group account management process executed by the server in the embodiment;

FIG. 5 is a flow chart showing the flow of a group account setting process executed by the server in the embodiment;

FIG. 6 is a flow chart showing the flow of an information sharing process executed by the server in the embodiment;

FIG. 7 is a flow chart showing the flow of an end data and time checking process executed by the server in the embodiment; and

FIG. 8 is a flow chart showing the flow of a group account deletion process executed by the server in the embodiment.

### DESCRIPTION OF EMBODIMENTS

An example embodiment of a server, an information processing apparatus, a system, a method, and a program each according to the present disclosure will be described below based on the drawings.

However, the example embodiment described below is only illustrative of an embodiment and is not intended to limit the server, the information processing apparatus, the system, the method, and the program each according to the present disclosure to a specific configuration described below. In implementing the present disclosure, a specific configuration in accordance with the embodiment is used appropriately, and various changes and modifications may be made therein.

In the present embodiment, a description will be given of the example embodiment when the server, the information processing apparatus, the system, the method, and the program each according to the present disclosure are implemented in a system for sharing information at a conference. However, the server, the information processing apparatus, the system, the method, and the program each according to the present disclosure can be used widely for a technique for sharing information, and an object to which the present disclosure is to be applied is not limited to the example shown in the present embodiment.

<Configuration of System>

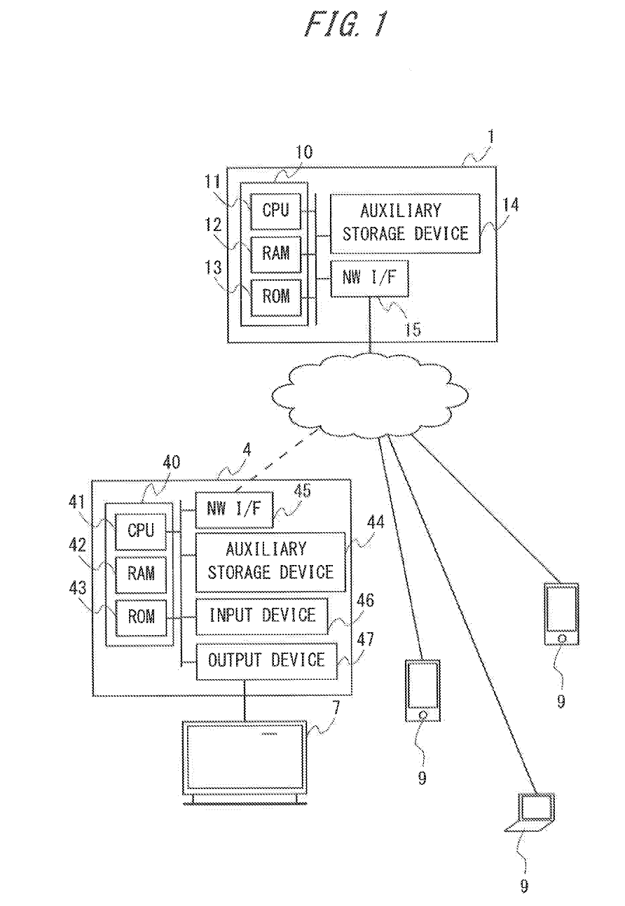

FIG. 1 is a view showing the outline of a configuration of a system according to the present embodiment. The system according to the present embodiment includes a server 1, and a single or plurality of information processing apparatuses 4. Each of the information processing apparatuses 4 is connected to the server 1 to be communicative therewith via a network such as a local area network (LAN) or the Internet. However, it is sufficient for the server 1 and the information processing apparatus 4 to share a character string for verification and an encryption key each described later in advance (e.g., at the time of factory shipment or the like), and the information processing apparatus 4 need not be connected to the network (may also be in a stand-alone state). As a result, the information processing apparatus 4 can immediately be brought into use even in a conference space without a network connection environment or the like.

The server 1 is a computer including a control section 10 including a central processing section (CPU) 11, a random access memory (RAM) 12, a read only memory (ROM) 13, and the like, an auxiliary storage device 14, and a communication interface 15. However, with regard to a specific hardware configuration of the server 1, a component can be omitted, replaced, or added appropriately in accordance with an example embodiment. Also, the server 1 is not limited to a single device. The server 1 may be implemented by a plurality of devices using a so-called cloud or distributed computing technique or the like.

The information processing apparatus 4 is a computer including a control section 40 including a CPU 41, a RAM 42, a ROM 43, and the like, an auxiliary storage device 44, a communication interface 45, an input device 46 such as a button, and an output device 47 such as a high-definition multimedia interface (HDMI) which outputs an image to a display device 7 such as a display or a projector. However, with regard to a specific hardware configuration of the information processing apparatus 4, a component can be omitted, replaced or added appropriately in accordance with an example embodiment.

As described above, the system according to the present embodiment is used as a system for sharing information at a conference. A typical conference is held by a plurality of persons assembling in the same place such as a conference room. Each of the information processing apparatuses 4 is provided in a conference room on a one-by-one basis and connected to a projector or display to display information. Each of the participants attending the conference holds a user terminal 9 connectable to the Internet. Here, the type of the user terminal 9 is not limited. Examples of the user terminal 9 include a smart phone, a personal computer, a tablet, and the like.

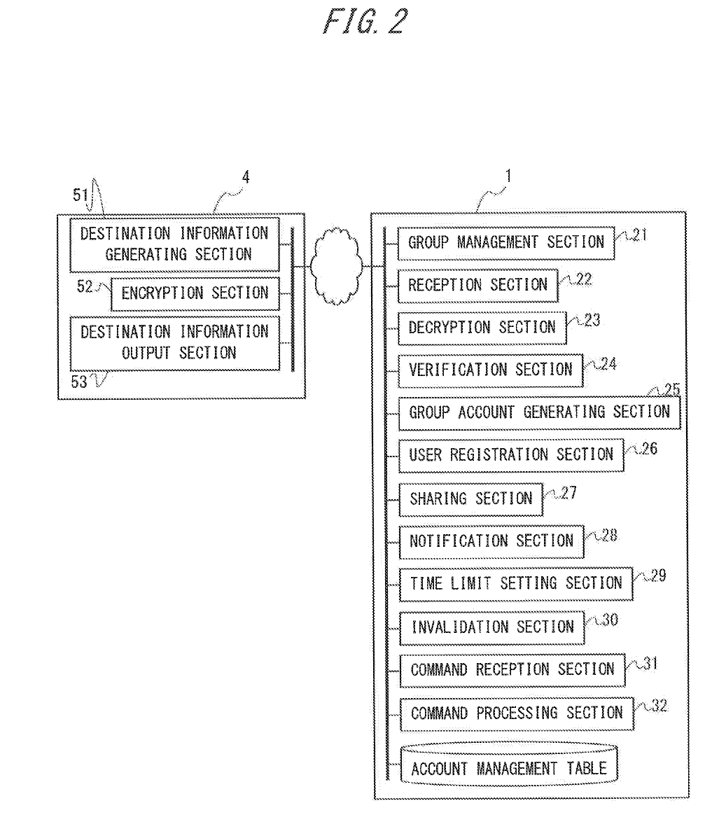

FIG. 2 is a view showing the outline of a functional configuration of the server 1 and the information processing apparatus 4 according to the present embodiment. In the server 1 according to the present embodiment, the CPU 11 interprets and executes various programs developed in the RAM 12 and controls various hardware items provided in the server 1 to function as a computer including a group management section 21, a reception section 22, a decryption section 23, a verification section 24, a group account generating section 25, a user registration section 26, a sharing section 27, a notification section 28, a time limit setting section 29, an invalidation section 30, a command reception section 31, and a command processing section 32. In the present embodiment, a description has been given of the example in which the functions of the server 1 are executed by the versatile CPU 11. However, some or all of the functions may also be implemented by a single or plurality of dedicated processors.

In each of the information processing apparatuses 4 according to the present embodiment, the CPU 41 interrupts and executes various programs developed in the RAM 42 and controls various hardware items provided in the information processing apparatus 4 to function as a computer including a destination information generating section 51, an encryption section 52, and a destination information output section 53. In the present embodiment, a description has been given of the example in which the functions of the information processing apparatus 4 are executed by the versatile CPU 41. However, some or all of the functions may also be implemented by a single or plurality of dedicated processors.

The destination information generating section 51 generates a temporary mail address for registration. The mail address for registration is a mail address used as the destination of an electronic mail transmitted to generate a group for information sharing or join the group. By generating the mail address for registration that is temporary, a period during which the mail address for registration can be acquired is limited to allow the users attending the same conference to join the same group. Note that, in the present embodiment, each of the information processing apparatuses 4 generates a new mail address for registration every time the button provided in the information processing apparatus 4 is pressed. Thus, the mail address for registration is generated as a temporary mail address to allow a group account to be generated for a group for information sharing which differs from one conference to another without making users particularly aware of that and allow only the persons who are there to share information. However, a method of generating the mail address for registration that is temporary is not limited to the method shown by way of example in the present embodiment. For example, it may also be possible that the information processing apparatus 4 generates different mail addresses for registration at given time intervals or the server 1 limits the period during which the same mail address for registration is received. Note that a process when a participant is added later to an existing group account will be described later.

Also, in the present embodiment, the destination information generating section 51 generates a mail address for registration including a character string encrypted by the encryption section 52. In addition, the destination information generating section 51 generates, as the mail address for registration, a mail address for registration including information used to set a time limit (which is a period of validity) to data sharing in the group for information sharing. Note that, in the present embodiment, the period of validity can be arbitrarily set via the Web interface of the information processing apparatus. It may also be possible to press and hold the button to change the period of validity in accordance with the time during which the button is held down and set the time of validity when the holding down of the button is stopped. Alternatively, it may also be possible to generate mail addresses for registration to which different periods of validity are set when the button in the information processing apparatus 4 is pressed and output these mail addresses for registration (in the form of, e.g., QR codes or the like).

The encryption section 52 encrypts the information including the data for verification that has been shared in advance between the information processing apparatus and the server.

The destination information output section 53 outputs the generated mail address for registration so as to allow only the user terminals 9 of the users attending at the same place to acquire the mail address for registration. Specifically, in the present embodiment, the destination information output section 53 outputs the mail address for registration to the display device 7 connected to the information processing apparatus 4, such as a display or projector, and causes the display device 7 to display the mail address for registration to thus allow only the users attending at the same place to acquire the mail address for registration. The information processing apparatus 4 has the Web interface and the destination information output section 53 transmits a Web page including the mail address for registration to the user terminal 9 which is newly connected to the Web interface.

Note that, in the present embodiment, in the case of outputting the mail address for registration to the display device 7, the destination information output section 53 outputs the mail address for registration in the form of a QR code (two-dimensional barcode). However, the mail address for registration may be output in any form as long as means readable by receiving devices is used, and the form in which the mail address for registration is output is not limited to the example shown in the present embodiment. As long as the user terminal 9 is an OCR-capable terminal, the mail address for registration may also be output and displayed in a character string.

The group management section 21 manages the account of the group for information sharing and the users belonging to the group. In the present embodiment, the group management section 21 manages the account of the group for information sharing and the users belonging to the group using an account management table produced for each group account. The account management table includes the mail address for registration of the group account managed with the account management table, a mail address for sharing, participant mail addresses, a deletion flag showing the validity/invalidity of the account, the period of validity of information sharing, the media access control (MAC) address of the information processing apparatus 4 that has issued the mail address for registration, date and time information related to the generating of the mail address for registration, a final sharing date and time, and the like. However, the management of the group may also be performed using a database other than the account management table.

The reception section 22 receives a message transmitted from the user terminal 9 that has acquired the mail address for registration (destination information) generated by the information processing apparatus 4 by setting the mail address for registration to the destination. Note that, in the present embodiment, a message transmitted from the user terminal 9 for the generating of a group or the registration of a participant is an electronic mail using any address within the domain of the server 1 as the destination. To the destination of the electronic mail, the mail address for registration is set which has been generated by the information processing apparatus operable by the user of the user terminal 9 and output to be acquirable by the user terminal 9. When transmitted for participation in the group, the electronic mail may also be a so-called “blank mail” having no content in the title and text thereof. Note that the server 1 need not know the mail address for registration in advance. That is, in the present embodiment, the reception section 22 receives the electronic mail transmitted from the user terminal 9 irrespective of whether or not the group account corresponding to the destination of the electronic mail is managed by the group management section 21.

The reception section 22 also receives data transmitted from the user terminal 9 of a participant belonging to the group to the mail address for sharing.

The decryption section 23 decrypts a part (the entire local part in the present embodiment) of the mail address for registration set to the destination of the received electronic mail.

The verification section 24 compares a part of the information obtained through the decryption by the decryption section 23 to the character string for verification that has been held in advance to verify that the mail address for registration set to the destination of the electronic mail has been generated by a valid information processing apparatus. To each of the information processing apparatuses 4, a different character string for verification has been set in advance. The server 1 holds the character strings for verification in association with information (MAC addresses in the present embodiment) which allows the information processing apparatuses 4 to be identified and checks, upon receipt of the mail address for registration, whether or not a combination of the MAC address obtained by decrypting the local part and the character string for verification is correct.

The group account generating section 25 generates, when the group account corresponding to the mail address for registration set to the destination of the received electronic mail is not managed by the group management section 21, a group account corresponding thereto. Note that, in the present embodiment, the group account generating section 25 generates a group account in which the mail address for sharing (identification information) is different from the mail address for registration set to the destination of the electronic mail. The mail address for sharing is a mail address used as a destination for specifying a group when a participant transmits data wished to be shared. However, the mail address for registration and the mail address for sharing need not necessarily be different addresses. Instead of the method used in the present embodiment, a method may also be used in which the group account generating section 25 generates a group account in which the mail address for sharing is identical to the mail address for registration.

The user registration section 26 registers the transmitter of the received electronic mail as a participant (user) belonging to a group corresponding to the mail address for registration set to the destination of the electronic mail.

The sharing section 27 causes data to be shared by the participants belonging to the group specified in the transmission of the data. Note that, in the present embodiment, for data sharing, a mailing list method is used in which data transmitted to the group account is simultaneously transmitted (transferred) to the multiple mail addresses of the participants belonging to a group. However, the method for data sharing is not limited to a mailing list.

The notification section 28 notifies the participants registered by the user registration section 26 of the mail address for sharing and the mail address for registration each corresponding to the registered group account. Here, the notification section 28 sends the notification of the mail address for registration in a form which allows the mail address for registration to be acquired with sensors (e.g., optical sensors such as cameras) provided in the terminals of the other participants and a user who wishes to join the group after the completion of a conference. Note that, in the present embodiment, the notification of the mail address for registration is sent in the form of a QR code. This allows the user terminals 9 having cameras to easily acquire the mail address for registration and allows the mail address for registration to propagate. However, the form of the notification of the mail address for registration is not limited to the form shown by way of example in the present embodiment. For example, the mail address for registration may also be distributed as an NEC tag. The mail address for registration may also be distributed in a form which requires manual input by a user. However, when the mail address for registration is distributed in a form which allows the mail address for registration to be acquired with the sensor of the user terminal 9, it is possible to omit the labor of manual input by the user.

The time limit setting section 29 sets a time limit to data sharing in the group based on the mail address for registration set to the destination of an electronic mail. In the present embodiment, as the time limit to data sharing, an end date and time is set. The end date and time is calculated by adding a preset period of validity to the date and time when data sharing is finally performed. However, the method of setting the time limit is not limited to the example shown in the present embodiment.

The invalidation section 30 invalidates the sharing by the sharing section 27 for each group account based on the end date and time. Note that, in the present embodiment, the invalidation/validation of a group account is performed by operating the deletion flag set in the account management table.

The command reception section 31 receives a command. In the present embodiment, a command is written in the title part of an electronic mail addressed to the mail address for registration in accordance with a predetermined format. Note that, when information other than a command, i.e., a character string not compliant with the predetermined format is input, the character string is interpreted as the name of a group account and the transmitter of this mail is interpreted as a new manager.

The command processing section 32 performs at least any of the processes of the addition/removal of a participant to/from the group, the acquisition of information on the participants of the group, the change of the time limit, and the validation/invalidation of information sharing in the group.

<Process Flow>

Next, the details of a process according to the present disclosure will be described. Note that the specific content, sequence, and the like of the process are illustrative examples in the execution thereof. The specific content, sequence, and the like of the process may be selected appropriately according to the embodiment.

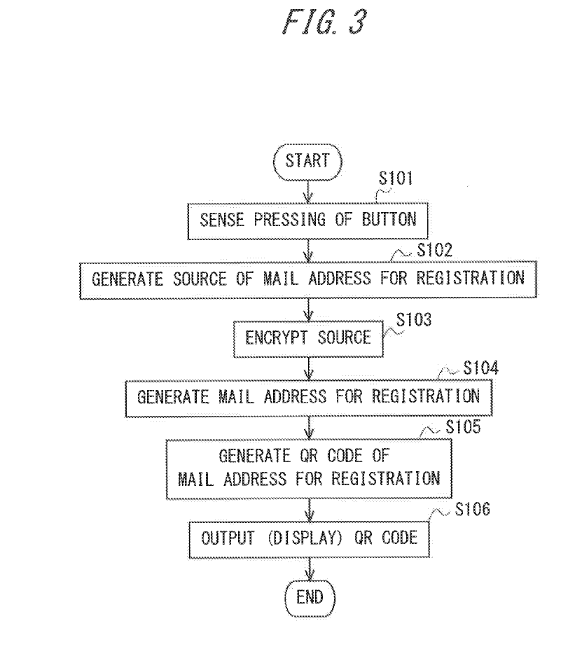

FIG. 3 is a flow chart showing the flow of the process executed by the information processing apparatus 4 in the present embodiment. The process shown in this flow chart is started in response to the operation of pressing the button provided in the information processing apparatus 4 (operation of notifying the mail address for registration to be output) performed by any of the participants of a conference. However, the operation that triggers the start of the process is not limited to the pressing of the button. The input device 46 provided in the information processing apparatus 4 may also be a device other than the button, such as a touch panel, and the operation of notifying the mail address for registration to be output performed by a user may also be an operation other than the pressing operation (such as, e.g., a gesture).

In Step S101, the pressing of the button is sensed. The control section 40 senses the pressing of the button provided as the input device 46 in the information processing apparatus 4 by the participant of the conference. In the present embodiment, the operation of pressing the button is a trigger (momentum) for generating the group account of a group for information sharing and starting the sharing of data. Then, the process advances to Step S102.

In Steps S102 to S104, the mail address for registration is produced. The destination information generating section 51 uses the preset period of validity of information sharing, the MAC address of the information processing apparatus 4, date and time information which allows the current date and time to be specified (which may be, e.g., a sequence of numbers representing a year, a date, an hour, a minute, and a second or the number of seconds elapsed from a given time point), and a character string for verification for determining whether or not decryption is possible to produce the source of the mail address for registration (Step S102). This source may be the foregoing information items arranged in succession. For example, when the period of validity is 1 hour (3600 seconds), the MAC address is 12:34:56:78:9A:BC, the current date and time is Sep. 15, 2013, 13:55:59, the character string for verification is ABCDEFGH, the source of the mail address for registration is “00003600123456789ABC20130915135559ABCDEFGH”. However, the information actually incorporated in the source, the number of digits thereof, and the like are not limited to the example shown in the present embodiment.

The encryption section 52 encrypts the source generated in Step S102 using the encryption key shared in advance between the server 1 and the information processing apparatus 4 (Step S103). Note that, in the present embodiment, a description will be given of an example which performs encryption using a common encryption key, but the key used for encryption may also be an asymmetrical key such as a public key. In addition, the encryption key may also be updated periodically or upon receipt of an instruction as long as the server 1 and the information processing apparatus 4 are communicative with each other via a network.

By generating the source by combining the foregoing information items and encrypting the source, it is possible to produce a sufficiently complicated mail address for registration which cannot be presumed by a third person who does not attend the conference. The destination information generating section 51 generates the mail address for registration using a character string generated by the encryption in Step S103 as the local part (left side of @) and using the preset domain of the server 1 as the domain part (right side of @) (Step S104). The generated mail address for registration is stored in the auxiliary storage device 44. Then the process advances to Step S105.

In Steps S105 and S106, the QR code of the mail address for registration is generated and displayed. The destination information output section 53 converts the mail address for registration generated in Step S104 to a QR code (Step S105). At this time, to the head of the mail address for registration, a character string “mailto:” for calling the mailer of the user terminal 9 may also be attached. Also, the QR code may include the character string of the conference name (e.g., “Predetermined Character String with Date”, specifically “Conference Sep. 15, 2013” etc.) to be acquired as the title (“Subject:”) of a mail by the mailer of the user terminal 9. Note that the character string set to the title can be edited via the Web interface of the information processing apparatus 4.

Then, the destination information output section 53 outputs image information including the QR code via the output device 47 to thus cause the display device 7 such as a display or projector to display the QR code (Step S106). The image information output from the destination information output section 53 may also include a URL (e.g., “http://192.168.1.1”) accessible by the Web interface of the information processing apparatus 4. Then, the process shown in this flow chart is ended.

Each of the participants of the conference senses the image of the QR code displayed by the display device 7 using the camera provided in the user terminal 9 thereof. The user terminal 9 acquires the image of the QR code via the camera and decodes the acquired image to thus acquire the mail address for registration. Then, the user transmits a mail to the mail address.

Note that, even when the user terminal 9 is incapable of sensing and decoding the image of the QR code, by manually inputting the URL displayed by the display device 7 to the Web browser of the user terminal 9, the user terminal 9 is allowed to be connected to the Web interface of the information processing apparatus 4 and acquire the mail address for registration. On accepting a Web connection from the user terminal 9 to the information processing apparatus 4, the destination information output section 53 of the information processing apparatus 4 transmits a Web page having the mail address for registration to the user terminal 9 to allow the user terminal 9 to acquire the mail address for registration. At this time, the mail address for registration can be acquired from the auxiliary storage device 44. The destination information output section 53 may also embed a code for giving the mail address for registration to the mailer of the user terminal 9 or a code for transmitting a mail from the information processing apparatus 4 to the mail address for registration in the Web page transmitted in response to the Web connection from the user terminal 9. Through the transmission of such a Web page having such a code embedded therein to the user terminal 9, a mail can be transmitted to the mail address for registration by such an easy operation of pressing a button in the Web page. However, to transmit a mail from the information processing apparatus 4 to the mail address for registration, it is necessary for the information processing apparatus 4 to have a mail transmitting function and be connected to the Internet.

Next, a description will be given of the content of a process at the server 1 when the electronic mail transmitted from the user terminal 9 of the participant of the conference to the mail address for registration or the mail address for sharing is received by the server 1.

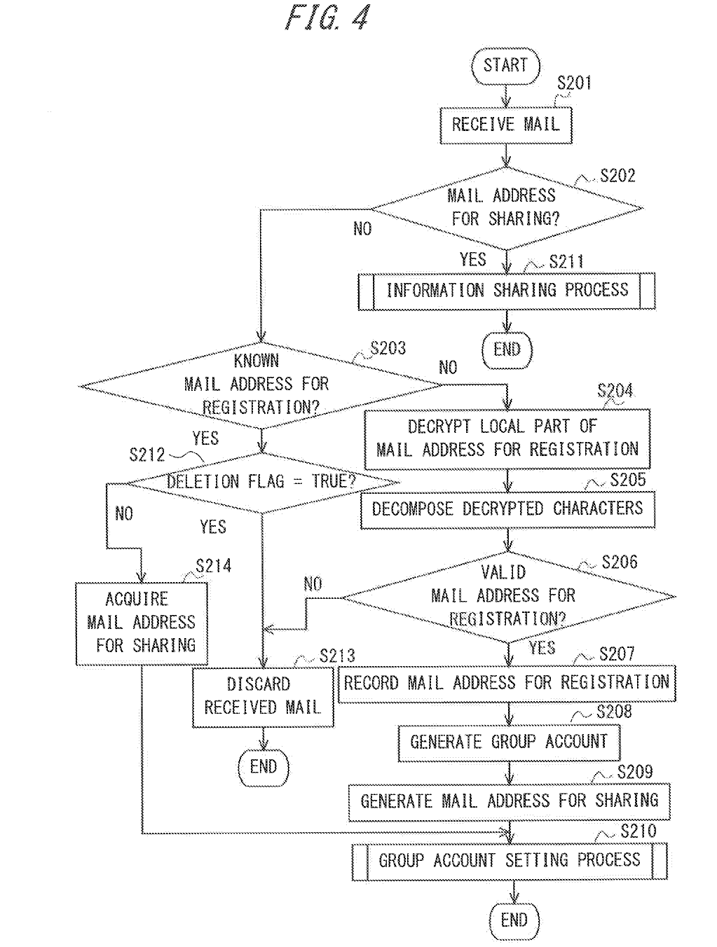

FIG. 4 is a flowchart showing the flow of a group account management process executed by the server 1 in the present embodiment. The process shown in this flow chart is started in response to the reception of the electronic mail by the server 1.

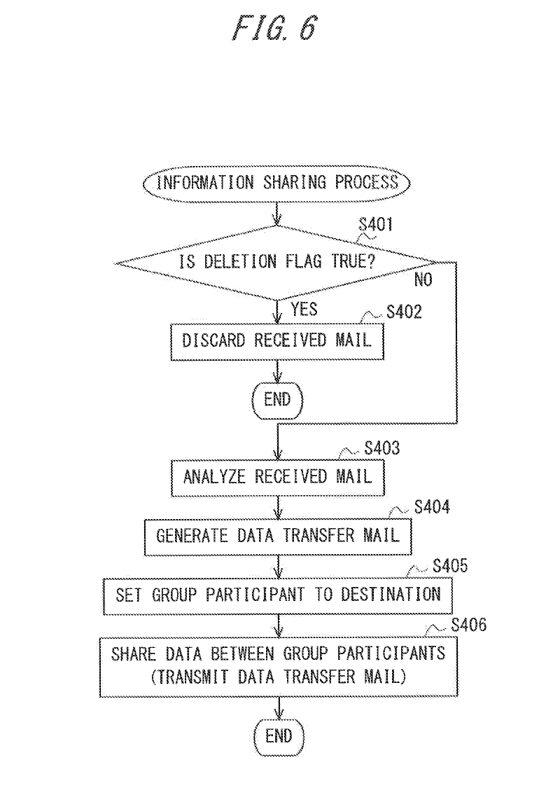

In Steps S201 and S202, the mail is received and it is determined whether or not the address set to the destination (“To:”) of the received mail is the registered mail address for sharing. The reception section 22 of the server 1 receives, of the mails transmitted from the user terminal 9, the mail in which the domain of the destination address is the domain of the server 1 (Step S201). In response to the reception of the mail addressed to the server 1, the group management section 21 determines whether or not the address set to the destination of the received mail has been registered as the mail address for sharing in the database (account management table) of the server 1 (Step S202). Here, when it is determined that the received mail is addressed to the registered mail address for sharing, the process advances to the information sharing process shown in Step S211. The details of the information sharing process will be described later using FIG. 6. On the other hand, when it is determined that the received mail is not addressed to the registered mail address for sharing, the process advances to Step S203.

In Step S203, it is determined whether or not the destination address of the received mail is a known mail address for registration (in other words, to which the corresponding mail address for sharing has already been set). The group management section 21 determines whether or not the address set to the destination of the received mail has been registered as the mail address for registration to which the corresponding mail address for sharing has already been set in the account management table of the server 1 (Step S203). Here, when it is determined that the received mail is addressed to the known mail address for registration, the process advances to Step S212.

On the other hand, when it is determined that the received mail is not addressed to the known mail address for registration, the process advances to Step S204 where the verification of the mail address for registration (see Steps S204 to S206) and the generating of a group account (see Steps S208 and Step S209) are performed. That is, in this system, the user terminal 9 of each of the participants can generate a new group account by transmitting a mail to an arbitrarily generated mail address which is not managed by the server 1.

In Steps S204 to S206, it is determined whether or not the address serving as the destination of the received mail is valid as a mail address for registration. First, the decryption section 23 decrypts the local part of the destination address of the received mail using the decryption key shared in advance between the server 1 and the information processing apparatus 4 (which is the same key as the encryption key used in Step S102 of FIG. 3 in the case of the common key method) (Step S204). Next, the verification section 24 decomposes the character string obtained by the decryption into the period of validity of information sharing, the MAC address of the information processing apparatus 4, the date and time information, and the character string for verification in accordance with a preset format (Step S205). Then, the verification section 24 determines whether or not each of the information items obtained by the decomposition satisfies predetermined conditions on a format, the number of characters, and a character string to thus determine whether or not the address serving as the destination of the received mail is valid as a mail address for registration (Step S206). Specifically, the verification section 24 makes determinations of: (1) whether or not the period of validity of information sharing has a value within a preset range in which the period of validity is settable; (2) whether or not the MAC address is in a list of the MAC addresses of the information processing apparatuses registered in advance in the server 1; (3) whether or not the date and time information has consistency (whether or not the date and time information shows a date and time in future or a date and time which does not exist); (4) whether or not the character string for verification is identical to the character string for verification of the information processing apparatus having the obtained MAC address which is shared in advance between the server 1 and the information processing apparatus 4; and the like to thus determine the validity of the mail address for registration. When it is determined that the destination address of the received mail is not a valid mail address for registration, the received mail is discarded (Step S213). On the other hand, when it is determined that the destination address of the received mail is a valid mail address for registration, the process advances to Step S207.

In Step S207, the mail address for registration is recorded in the database. The group management section 21 records the mail address for registration determined to be a valid mail address for registration in Step S206 in the database (which is the account management table in the present embodiment) of the server 1 for storing known mail addresses for registration. Thereafter, the recorded mail address for registration is treated as the known mail address for registration in the process in Step S203 described above. Also, the group management section 21 records the date and time of the transmission of the received mail having the destination to which the mail address for registration is set in the account management table in association with the mail address for registration. Then, the process advances to Step S208.

In Step S208, the group account is generated and the name of the group account (conference name) and the manager are set. The group account generating section 25 generates a group account, sets the title of the received mail as the name of the group account, and sets the mail address set to the transmitter of the received mail as the mail address of the manager (owner) of the group account. The group account generating section 25 also records the period of validity of information sharing, the MAC address of the information processing apparatus 4, and the date and time information each obtained in Step S205 in the account management table in association with the generated group account. Then, the process advances to Step S209.

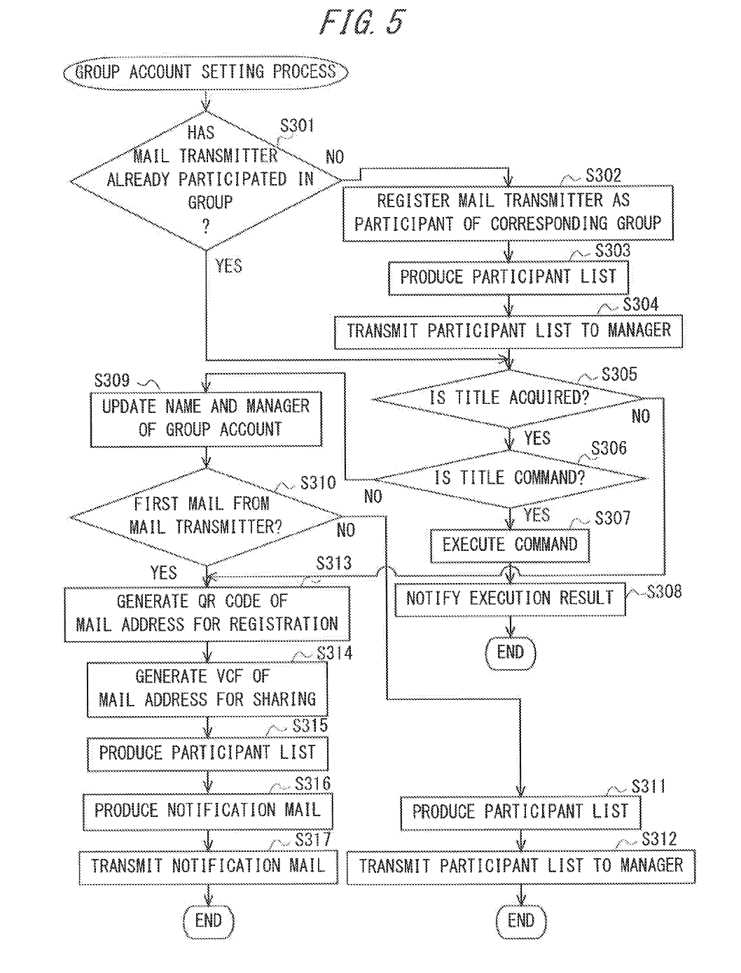

In Step S209, the mail address for sharing used in the generated group account is generated. The group account generating section 25 generates a mail address for sharing which is used as the destination of data transmitted when the data is shared between the users using the group account generated in Step S208. To make it difficult for a third person to presume the local part (left side of @) of the mail address for sharing, the local part of the mail address for sharing may include a randomly generated character string. However, in the local part of the mail address for sharing, the name of the group account may also be simply used. In the domain (right side of @) of the mail address for sharing, the domain of the server 1 is used. However, it is sufficient for the domain to be set to be a domain receivable by the server 1. Then, the process advances to the group account setting process shown in Step S210. The details of the group account setting process will be described later using FIG. 5.

In Steps S212 to S213, the process when it is determined in Step S203 that the received mail is addressed to the known mail address for registration is executed. The invalidation section 30 references the account management table to thus determine whether or not a deletion flag is set to the group account corresponding to the mail address for registration set to the destination of the received mail (whether or not the deletion flag is TRUE) (Step S212). When it is determined that the deletion flag is set, the invalidation section 30 discards the mail addressed to the mail address for registration that has been received in Step S201 (Step S213) so that the process shown in this flow chart is ended. On the other hand, when the deletion flag is not set (when the deletion flag is FALSE), the process advances to Step S214.

In Step S214, the group account is specified and the mail address for sharing is acquired. The group management section 21 searches the account management table to specify the group account corresponding to the mail address for registration set to the destination of the received mail and acquire the mail address for sharing. Then, the process advances to the group account setting process shown in Step S210.

FIG. 5 is a flow chart showing the flow of the group account setting process executed by the server 1. The process shown in this flow chart is started in response to the calling of the group account setting process in Step S210 in the group account management process of FIG. 4.

In Steps S301 and S302, when the transmitter of the mail has not been registered as a participant in the group account, participant registration is performed. The group management section 21 determines whether or not the mail address set to the transmitter (“From:”) of the mail received in Step S201 has already been registered as the mail address of a participant in a target group account (Step S301). The determination is made by referencing the account management table of the group account corresponding to the mail address for registration set to the destination of the mail. When the transmitter of the mail has been registered as a participant, the process advances to Step S305. On the other hand, when the transmitter of the mail has not been registered as a participant, the process advances to Step S302. The user registration section 26 extracts, from the received mail, the address set to the transmitter (“From:”) of the mail and registers the address as a participant in the corresponding group account (Step S302). At this time, the group management section 21 records the date and time of the transmission of the mail as the final sharing date and time in the corresponding group account. Then, the process advances to Step S303.

In Steps S303 and S304, a participant list is produced and transmitted to the manager. The group management section 21 extracts the participant currently registered in the group account and produces the participant list (list of participants) (Step S303). Then, the group management section 21 transmits the produced participant list to the mail address registered as the manager of the group account (Step S304). This allows the manager to recognize an increase in the participants who use the group account. Then, the process advances to Step S305.

In Steps S305 to S308, the title of the received mail is acquired. When a command is set to the title, the acquired command is executed. The control section 10 acquires the character string set to the title (“Subject:”) of the received mail (Step S305). When the character string is not acquired here, the process advances to Step S313. On the other hand, when the character string is acquired, the command reception section 31 determines whether or not the acquired character string is a command to the server 1 (Step S306). In the present embodiment, when “#” is set to the head of the character string, the subsequent character string is interpreted as a command. When it is determined that the character string is a command, the command processing section 32 executes a process corresponding to the command (Step S307).

In the present embodiment, by writing a command in the title of a mail and transmitting the mail to the mail address for registration, the user can cause the server 1 to perform a process including the updating of the account management table, such as “Removal of All Participants”, “Change of Period of Validity”, “Invalidation of Mailing List”, “Validation of Invalidated Mailing List”, “Addition of Participant”, “Removal of Participant”, or “Acquisition of Participant List”. The command can be written as, e.g., “#add list (mail address)” when the user wishes the server 1 to execute the process of “Addition of Participant”. However, the format of the command is not limited to the one shown by way of example in the present embodiment. The command processing section 32 executes the process in accordance with the command and then transmits a mail having the result of the execution to the transmitter of the command (Step S308). Then, the process shown in this flow chart is ended.

On the other hand, when it is determined in Step S306 that the character string is not a command, the process advances to Step S309.

In Step S309, the name of the group account (conference name) and the manager thereof are set again. The group management section 21 sets the title of the received mail as the new name of the group account and sets the mail address set to the transmitter of the received mail as the mail address of a new manager of the group account. That is, in the present embodiment, by transmitting a mail in which a character string not interpreted as a command is set to the title (Subject:) to the known mail address for registration, it is possible to set the name of the group account to the title and set the manager of the group account corresponding to the mail address for registration to the transmitter. In the present embodiment, the setting of the name using the title and setting of the manager is based on a “win-later” method so that the title of the mail to which a title other than the command finally received by the server 1 is set becomes the name of the group account and the transmitter of the mail becomes the manager of the group account. Then, the process advances to Step S310.

In Steps S310 to S312, when the received mail is a first mail from the transmitter to the mail address for registration, the latest participant list is transmitted to the manager. The group management section 21 determines whether or not the received mail is the first mail from the transmitter of the mail to the mail address for registration (Step S310). The determination may be performed by referencing the reception history of mails to the mail address for registration or referencing the result of the determination in Step S301. When it is determined in Step S301 that the address of the transmitter of the received mail has not been registered yet in the group account, it can be determined that the received mail is the first mail to the mail address for registration. When it is determined in Step S301 that the address of the transmitter of the received mail has already been registered in the group account, it can be determined that the received mail is not the first mail to the mail address for registration.

When it is determined that the received mail is not the first mail from the transmitter of the received mail to the mail address for registration, the participant list production process and the participant list transmission process are performed (Steps S311 and S312). The participant list production process and the participant list transmission process are generally the same as the processes described in Step S303 and S304 so that a description thereof is omitted. When the transmission of the participant list is completed, the process shown in this flow chart is ended. That is, in the present embodiment, when the received mail is not for first registration, after the transmission of the participant list, the process is ended and the notification of the mail address for sharing (see Step S317) is not performed.

On the other hand, when it is determined in Step S310 that the received mail is the first mail from the transmitter of the received mail to the mail address for registration, the process advances to Step S313.

In Step S313, the QR code of the mail address for registration is generated or acquired. The notification section 28 converts the mail address for registration to the QR code or reads the QR code converted previously and stored in association with the group account. At this time, to the head of the mail address for registration, a character string “mailto:” for calling the mailer of the user terminal 9 may also be attached. Then, the process advances to Step S314.

In Step S314, data (VCF) in a vCard form (standard for an electronic name card) is generated or acquired. The notification section 28 newly generates VCF including the name of the group account (conference name), the mail address for sharing, and the like or reads the VCF generated previously and stored in association with the group account. Then, the process advances to Step S315.

In Step S315, the latest participant list is acquired. Since the participant list production process is generally the same as the process described in Step S303, a description thereof is omitted. Then, the process advances to Step S316.

In Steps S316 and S317, a mail for the notification of the mail address for sharing is generated, and the resulting mail-address-for-sharing notification mail is transmitted. The notification section 28 generates the mail-address-for-sharing notification mail which includes the QR code of the mail address for registration generated/acquired in Step S313, the VCF generated/acquired in Step S314, and the participant list acquired in Step S315 (Step S316). The title or text of the notification mail may also contain a statement compliant with a preset format which notifies that the mail is the notification mail of the mail address for sharing, that, if information is transmitted to the mail address for sharing shown in the VCF, the information can be shared between the participant of the group account, that, if there is another person who is wished to be a participant, the person can be notified of the mail address for registration by causing the person to sense the image of the QR code, or the like. Then, the notification section 28 transmits the mail-address-for-sharing notification mail to the transmitter of the mail received in Step S201 (Step S317). Then, the process shown in this flow chart is ended.

By transmitting information (data) to be shared to the mail address for sharing attached to the received notification mail, the information can be easily and conveniently shared between the participants of the group. In addition, each of the participants can cause the display of the terminal thereof to display the QR code of the mail address for registration and allow another user who is wished to join the group to sense the image of the QR code. Another user who wishes to newly join the group senses the image of the QR code displayed using the terminal thereof and transmits a mail to the obtained mail address for registration to be thereby allowed to join the group.

FIG. 6 is a flow chart showing the flow of the information sharing process executed by the server 1. The process shown in this flow chart is started at the moment when it is determined in Step S202 of the group account management process of FIG. 4 that the received mail is addressed to the registered mail address for sharing and the information sharing process is called in Step S211 thereof.

In Steps S401 and 402, when the deletion flag is set, the received mail is discarded. The invalidation section 30 determines whether or not the deletion flag is set to the group account corresponding to the mail address for sharing set to the destination of the received mail (whether or not the deletion flag is TRUE) (Step S401). When it is determined that the deletion flag is set, the invalidation section 30 discards the mail addressed to the mail address for sharing that has received in Step S201 (Step S402). On the other hand, when the deletion flag is not set (when the deletion flag is FALSE), the process advances to Step S403.

In Step S403, the received mail is analyzed. The sharing section 27 extracts the data attached to the received mail and stores the extracted data as the shared data of the group account in the auxiliary storage device 14 of the server 1 (which may also be an external database). In addition, the group management section 21 records the date and time of transmission set to the received mail as the final sharing date and time in the account management table. However, the date and time recorded as the final sharing date and time may also be the date and time of reception when the mail is actually received by the server 1. Then, the process advances to Step S404.

In Step S404, a data transfer mail is generated. By attaching the data extracted from the received mail in Step S403 as data to be shared to a new mail, the sharing section 27 generates the data transfer mail. Note that, as the title and text of the data transfer mail, the title and text of the mail received in Step S201 may also be used. In other words, the new mail is the transferred mail of the mail received in Step S201. Then, the process advances to Step S405.

In Steps S405 and S406, to the destination of the data transfer mail, the mail addresses of the group participants are set, and the data transfer mail is transmitted. The sharing section 27 reads all the mail addresses of the participants associated with the target group account from the account management table and sets the read mail addresses to the destination of the data transfer mail (Step S405). However, when there is a mail set to be excluded from the destination of the data to be shared, the excluded mail address is not set to the destination. Note that a field to which the mail addresses of the participants are set may be “To:”, “CC:”, or “BCC:”. To the head row of the text of the data transfer mail, the mail address of the transmitter of the data to be shared is written. When the destination is set, the sharing section 27 transmits the data transfer mail to thus allow the data to be shared to be shared between the participants of the group (Step S406). Then, the process shown in this flow chart is ended.

Next, a description will be given of a group account invalidation process. In the system shown in the present embodiment, when a predetermined end date and time is passed, the group account is invalidated to thus reduce the labor of management and prevent an irrelevant third person from joining the group. By further deleting the group account with a predetermined timing, the data is prevented from remaining online. Note that, when the period of duration of the group account is not limited, the group account invalidation process need not be performed.

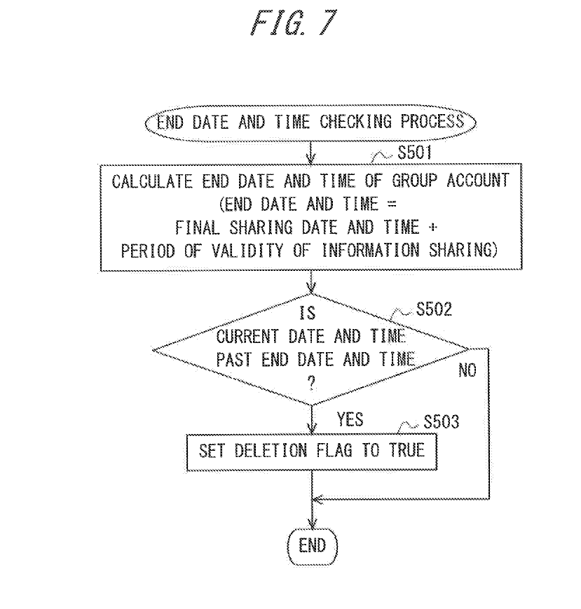

FIG. 7 is a flow chart showing the flow of an end date and time checking process executed by the server 1. The process shown in this flow chart is periodically executed at relatively short intervals (e.g., every other minute). Note that the interval of the execution of the end date and time checking process may also be set to be changeable.

In Steps S501 and S502, the end date and time of the group account is calculated and checked. The time limit setting section 29 calculates the end date and time for each of the group accounts managed by the server 1 (Step S501). In the present embodiment, the end date and time is calculated in accordance with the following calculation expression:

End Date and Time=Final Sharing Date and Time+Period of Validity of Information Sharing.

Here, the final sharing date and time is the date and time which is updated every time the mail addressed to the mail address for sharing is received in Step S403 and the period of validity of information is the period of validity set to the account management table (see Steps S204 to S208 of FIG. 4 and Steps S305 to S308 of FIG. 5). When the end date and time is calculated, the control section 10 determines, for each of the group accounts managed by the server 1, whether or not the current date and time (the date and time of the execution of the batch process shown in this flow chart) is past the calculated end date and time (Step S502). When it is determined that the current date and time is not past the end date and time (is within the period of validity), the process shown in this flowchart is ended. On the other hand, when it is determined that the current date and time is past the end date and time, the process advances to Step S503.

In Step S503, the deletion flag is set. The invalidation section 30 sets the deletion flag of the group account for which it is determined that the current date and time is past the end date and time to TRUE in the account management table and thus invalidates information sharing in the corresponding group account. Then, the process shown in this flow chart is ended.

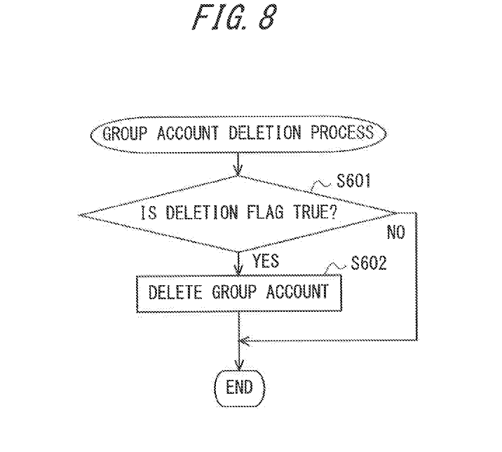

FIG. 8 is a flowchart showing the flow of a group account deletion process executed by the server 1. The process shown in this flow chart is periodically executed at relatively long intervals (e.g., every other year). Note that the interval of the execution of the group account deletion process may also be set to be changeable.

In the group account deletion process, when the deletion flag is set, the group account is deleted. The group management section 21 checks, for each of the group accounts managed by the server 1, whether or not the deletion flag is TRUE (Step S601). When the deletion flag is set to TRUE, the group management section 21 deletes all the data items related to the corresponding group account, such as the account management table and the shared data (Step S602). On the other hand, when the deletion flag is not set or is FALSE, the process shown in this flow chart is ended.

<Variations>

In the present embodiment, the description has been given of the example using an electronic mail for information communication between the server 1 and each of the terminals. However, for the communication between the server 1 and each of the user terminals 9, a message transmission/reception service other than a so-called electronic mail may also be used.

Also, in the present embodiment, the description has been given of the example in which mail delivery using a mailing list is used as means for information sharing. However, for information sharing, another means may also be used. For example, a so-called file sharing service may also be used in which the user terminal 9 of a participant accesses a predetermined file server and acquires data therefrom.

Also, in the present embodiment, the description has been given of the example which uses the information processing apparatuses 4 each disposed at a place where the users assemble to generate and display the mail address for registration. However, to generate and display the mail address for registration, another means may also be used. For example, the mail address for registration may also be generated in advance at a place other than the place where the users assemble or the addition of the character string for verification or the encryption thereof may also be omitted. The mail address for registration may also be printed on a medium such as a paper sheet or a sticker and distributed or posted or may be output using a sound or voice from a speaker or the like and acquired using the sound/voice recognizing function of the user terminals 9.

What is claimed is:

1. A server, comprising:
a group management unit that manages on a group-by-group basis a user belonging to a group for information sharing;
a message reception unit that receives a message transmitted from a user terminal;
a time limit setting unit that sets a time limit for data sharing in the group based on destination information of the message;
a data reception unit that receives data transmitted from the user terminal of the user belonging to the group;
a sharing unit that causes the data to be shared by users belonging to a group specified when the data is transmitted; and
an invalidation unit that invalidates the data sharing by the sharing unit in accordance with the time limit.

2. The server according to claim 1, wherein, to a destination of the message, the destination information is set which is generated by an information processing apparatus operable by the user of the user terminal and which is output by the information processing apparatus so that the destination information is acquirable by the user terminal.

3. The server according to claim 1, wherein
the group management unit further manages an account of the group for information sharing, and
the server further comprising:
a group account generating unit that generates, when a group account corresponding to a destination of the received message is not managed by the group management unit, a group account corresponding thereto.

4. The server according to claim 1, further comprising:
a user registration unit that registers a transmitter of the received message as a user belonging to a group corresponding to a destination of the message.

5. The server according to claim 1, further comprising:
a command reception unit that receives a command; and
a command processing unit that changes the time limit in accordance with content of the command.

6. The server according to claim 1, wherein the message reception unit receives the message transmitted from the user terminal irrespective of whether or not a group account corresponding to a destination of the message is managed by the group management unit.

7. An information processing apparatus, comprising:
a destination information generating unit that generates, as temporary destination information, destination information including information used to set a time limit for data sharing in a group for information sharing; and
a destination information output unit that outputs the generated destination information so that the destination information is acquirable by a user terminal.

8. The information processing apparatus according to claim 7, wherein the destination information output unit outputs the destination information so as to allow only the user terminals of users attending at a common place to acquire the destination information.

9. A method to be executed by a computer, comprising:
managing on a group-by-group basis a user belonging to a group for information sharing;
receiving a message transmitted from a user terminal;
setting a time limit for data sharing in the group based on destination information of the message;
receiving data transmitted from the user terminal of the user belonging to the group;
causing the data to be shared by users belonging to a group specified when the data is transmitted; and
invalidating the sharing in the sharing in accordance with the time limit.

10. A computer-readable non-transitory medium recorded with a program for causing a computer to function as:
a group management unit that manages on a group-by-group basis a user belonging to a group for information sharing;
a message reception unit that receives a message transmitted from a user terminal;
a time limit setting unit that sets a time limit for data sharing in the group based on destination information of the message;
a data reception unit that receives data transmitted from the user terminal of the user belonging to the group;
a sharing unit that causes the data to be shared by users belonging to a group specified when the data is transmitted; and
an invalidation unit that invalidates the data sharing by the sharing unit in accordance with the time limit.
